(19) United States
(12) Patent Application Publication
(10) Pub. No.: US 2012/0134591 A1
(43) Pub. Date: May 31, 2012

(54) IMAGE PROCESSING APPARATUS, IMAGE PROCESSING METHOD AND COMPUTER-READABLE MEDIUM

(75) Inventor: Shunichi KIMURA, Kanagawa (JP)

(73) Assignee: FUJI XEROX CO., LTD., Tokyo (JP)

(21) Appl. No.: 13/083,174

(22) Filed: Apr. 8, 2011

(30) Foreign Application Priority Data
Nov. 30, 2010 (JP) 2010-265968

(51) Int. Cl. G06K 9/18

(52) U.S. Cl. 382/185

(57) ABSTRACT

An image processing apparatus includes a cutout position extraction unit, a character candidate extraction unit, a graph generation unit, a link value generation unit, a path selection unit and an output unit. The cutout position extraction unit extracts a cutout position. The character candidate extraction unit recognizes each character for each character image divided by the cutout position and extracts a plurality of character candidates for each recognized character. The graph generation unit sets each of the plurality of extracted character candidates as a node and generates a graph by establishing links between the nodes of adjacent character images. The link value generation unit generates a link value based on a value of character-string-hood representing a relationship between character candidates. The path selection unit selects a path in the generated graph based on the link value. The output unit outputs a character candidate string in the selected path.

### CROSS-REFERENCE TO RELATED APPLICATION

This application is based on and claims priority under 35 USC 119 from Japanese Patent Application No. 2010-265968 filed on Nov. 30, 2010.

### BACKGROUND

1. Technical Field

The present invention relates to an image processing apparatus, an image processing method and a computer-readable medium.

2. Related Art

Techniques for cutting characters out of an image are known in the art.

### SUMMARY

According to an aspect of the invention, an image processing apparatus includes a cutout position extraction unit, a character candidate extraction unit, a graph generation unit, a link value generation unit, a path selection unit and an output unit. The cutout position extraction unit extracts a cutout position to divide character images from an image. The character candidate extraction unit recognizes each character for each character image divided by the cutout position extracted by the cutout position extraction unit and extracts a plurality of character candidates for each recognized character. The graph generation unit sets each of the plurality of character candidates extracted by the character candidate extraction unit as a node and generates a graph by establishing links between the nodes of adjacent character images. The link value generation unit generates a link value based on a value of character-string-hood which represents a relationship between character candidates of the nodes connected by the links. The path selection unit selects a path in the graph generated by the graph generation unit based on the link value generated by the link value generation unit. The output unit outputs a character candidate string in the path selected by the path selection unit as a result of character recognition of the image processing apparatus.

### BRIEF DESCRIPTION OF THE DRAWINGS

Exemplary embodiment of the invention will be described in detail based on the following figures, wherein:

FIG. 1 is a conceptual module configuration view of an example configuration according to this embodiment;

FIG. 2 is a conceptual module configuration view of an example configuration of a link value generation module;

FIG. 3 is a conceptual module configuration view of an example configuration of a path selection module;

FIG. 4 is a flow chart illustrating an example of process according to this embodiment;

FIG. 5 is an explanatory view illustrating an example of graph in the presence of a plurality of character candidates;

FIG. 6 is an explanatory view illustrating an example of symbol;

FIG. 7 is an explanatory view illustrating an example of symbol;

FIG. 8 is an explanatory view illustrating an example of symbol;

FIG. 9 is an explanatory view illustrating an example of symbol;

FIG. 10 is an explanatory view illustrating an example of symbol;

FIG. 11 is an explanatory view illustrating an example of using intra-node information;

FIGS. 12A and 12B are explanatory views illustrating an example of node and link;

FIG. 13 is an explanatory view illustrating an example of process in the presence of a plurality of character cutout positions;

FIG. 14 is an explanatory view illustrating an example of symbol;

FIG. 15 is an explanatory view illustrating an example of process in the presence of a plurality of character cutout positions;

FIGS. 16A, 16B, 16C, 16D, 16E, 16F and 16G are explanatory views illustrating an example of weighting;

FIG. 17 is an explanatory view illustrating an example of module configuration of a weighting determination module;

FIG. 18 is an explanatory view illustrating an example of weighting;

FIG. 19 is an explanatory view illustrating an example of weight;

FIGS. 20A, 20B, 20C, 20D, 20E, 20F and 20G are explanatory views illustrating an example of weighting;

FIG. 21 is an explanatory view illustrating an example of module configuration of a weighting determination module;

FIG. 22 is a block diagram illustrating an example of hardware configuration of a computer implementing this embodiment;

FIG. 23 is an explanatory view illustrating an example of character string image;

FIG. 24 is an explanatory view illustrating an example of character boundary candidate;

FIG. 25 is an explanatory view illustrating an example of circumscribed rectangle;

FIGS. 26A, 26B, 26C and 26D are explanatory views illustrating an example of character cutout result;

FIG. 27 is an explanatory view illustrating an example of graphical representation showing a character cutout position;

FIG. 28 is an explanatory view illustrating an example of pattern in a graphical representation; and

FIG. 29 is an explanatory view illustrating an example of graph.

### DETAILED DESCRIPTION

This embodiment involves determining a result of recognition of a character in an image including a character string.

Prior to description of this embodiment, the premise of the description or an image processing apparatus using this embodiment will be first described. This description is intended to facilitate understanding of this embodiment.

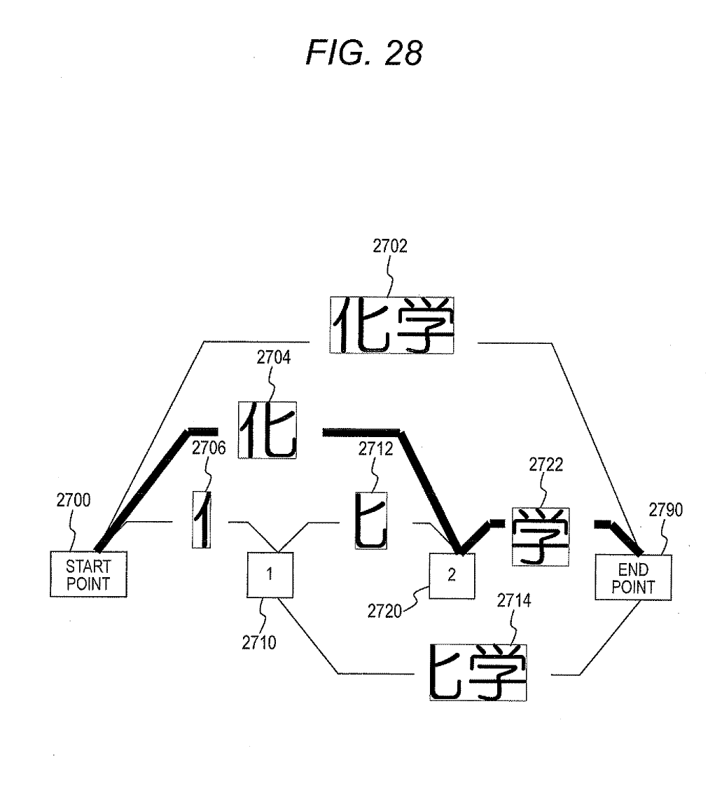

For example, description will be given in regard to a character string image as illustrated in FIG. 28. First, this character string image is divided into character segments. As used herein, the term ‘character segment’ refers to a character portion which may become a character itself or a portion of the character. Here, a horizontally-written character string image as shown in FIG. 28 will be described by way of example. The horizontally-written image is divided into character segments by a vertical line (or a substantially vertical line). For example, a character string image is divided into 3 character segments, “ [symbol] ”, “ [symbol] ” and “ [symbol] ” by vertical lines (a cut line candidate 2410 and a cut line candidate 2420) shown in FIG. 24. The vertical lines illustrated in FIG. 24 are called “cut line candidates.” The cut line candidate 2410 separates “ [symbol] ” and “ [symbol] ” and the cut line candidate 2420 separates “ [symbol] ” and “ [symbol] .”

Next, as illustrated in FIG. 25, respective circumscribed rectangles (a circumscribed rectangle 2510, a circumscribed rectangle 2520 and a circumscribed rectangle 2530) for the character segments are extracted.

Technical contents described in JP-A-62-190575 will be hereinafter described by way of example. Although terms used in the following description may be sometimes different from terms used in JP-A-62-190575, the technical contents are the same as the technical contents of JP-A-62-190575.

The above-mentioned character segments are combined to determine a character image. In some cases, a plurality of character segments may be combined to form one character image, or in other cases, one character segment may form one character. Since determination of a character image is equivalent to determination of a character cutout position, and thus, the former may be sometimes termed as the latter.

There exists a plurality of patterns of combination of character segments. Among these, a final character cutout position is determined by selecting the one having the highest character image evaluation value.

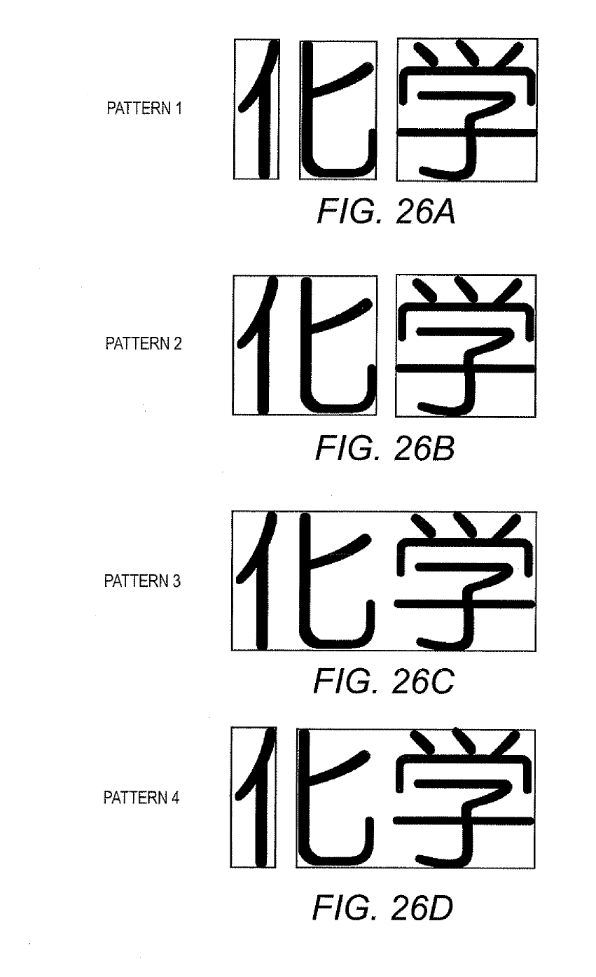

All of the character cutout patterns for the example shown in FIG. 25 are as shown in examples of FIG. 26A to 26D. Specifically, an example of FIG. 26A shows three character images (a circumscribed rectangle 2510, a circumscribed rectangle 2520 and a circumscribed rectangle 2530) as a first pattern, an example of FIG. 26B shows two character images (a circumscribed rectangle 2510 and 2520 and a circumscribed rectangle 2530) as a second pattern, an example of FIG. 26C shows one character image (a circumscribed rectangle 2510, 2520 and 2530) as a third pattern, and an example of FIG. 26D shows two character images (a circumscribed rectangle 2510 and a circumscribed rectangle 2520 and 2530) as a fourth pattern.

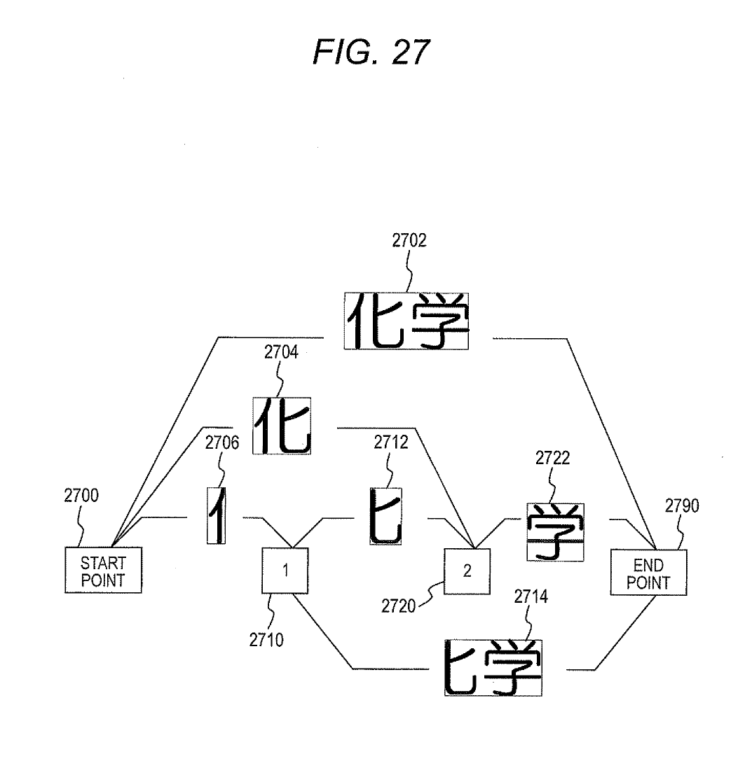

The plurality of cutout patterns shown in the examples of FIGS. 26A to 26D may be represented by a graph depicting character cutout positions. In an example of FIG. 27, a graph includes four nodes: a start node 2700, an end node 2790, a middle node 2710 (a first node) and a middle node 2720 (a second node), and arcs interconnecting between nodes (a connecting line between nodes is here called an arc). A start point corresponds to the left end point of a character string image and an end point corresponds to the right end point of the character string image. The middle node 2710 (the first node) and the middle node 2720 (the second node) represent respective character paragraph candidate positions (that is, the paragraph candidate 2410 and the paragraph candidate 2420, respectively, as shown in the example of FIG. 24). The middle node 2710 (the first node) corresponds to the paragraph candidate 2410 and the middle node 2720 (the second node) corresponds to the cut line candidate 2420.

A route from the start point, through nodes, to the end point is hereinafter called a “path.” A path includes one or more arcs. Typically, there exists a plurality of paths. The character cutout patterns shown in the examples of FIG. 26A to 26D correspond to these paths. For example, the second pattern shown in the example of FIG. 26b corresponds to a path (a character cutout pattern 2704 and a character cutout pattern 2722) indicated by a bold line in FIG. 28.

Here, one character image candidate corresponds to one arc. For example, a character image (the character cutout pattern 2704), “ [symbol] ,” corresponds to an arc connecting the start node 2700 and the middle node 2720 (the second node). For a character corresponding to one arc, an evaluation value of that character can be determined. This is called an “arc evaluation value.”

An arc evaluation value is calculated based on character shape information, character recognition accuracy, etc. There exists a variety of arc evaluation value calculation methods, as disclosed in, for example, (1) JP-A-9-185681, (2) JP-A-8-161432, (3) JP-A-10-154207, (4) JP-A-61-175878, (5) JP-A-3-037782, and (6) JP-A-11-203406, etc.

One path includes a plurality of arcs. An evaluation value of the path constituted by the arcs may be calculated based on a plurality of arc evaluation values. This is here called a “path evaluation value.”

Among a plurality of paths, one path having the highest path evaluation value is selected to determine a character cutout position. Path selection allows determination of a character cutout position and cutout of a character as well as determination of a result of recognition of a cut character (character image).

For example, it is assumed that a bold line path is selected in the example of FIG. 28. In this case, character cutout positions correspond to three nodes, that is, the start node 2700, the middle node 2720 (the second node) and the end node 2790. A determined character recognition result corresponds to “ [symbol] ” (the character cutout pattern 2704) and “ [symbol] ” (the character cutout pattern 2722).

A path evaluation value calculation method will be described. A path evaluation value is basically calculated based on the sum of weights of arc evaluation values. Assuming that Vi represents an arc evaluation value of an i-th arc, wi represents a weight for the i-th arc evaluation value, N represents the number of arcs and P represents a path evaluation value, P is expressed by the following equation (1).

$$P = {\sum }_{i = 1}^{N} {w}_{i} {V}_{i} \qquad [ Equation 1 ]$$

As described above, there exist a plurality of paths; however, the number of paths is enormous since there exist many character segments in actual character strings.

In this connection, JP-A-3-225579 discloses a dynamic programming method for searching for a path having the highest evaluation value among a plurality of paths in a graph as shown in the example of FIG. 27. This document describes a Viterbi algorithm suitable for searching for the best path in the graph in the dynamic programming method.

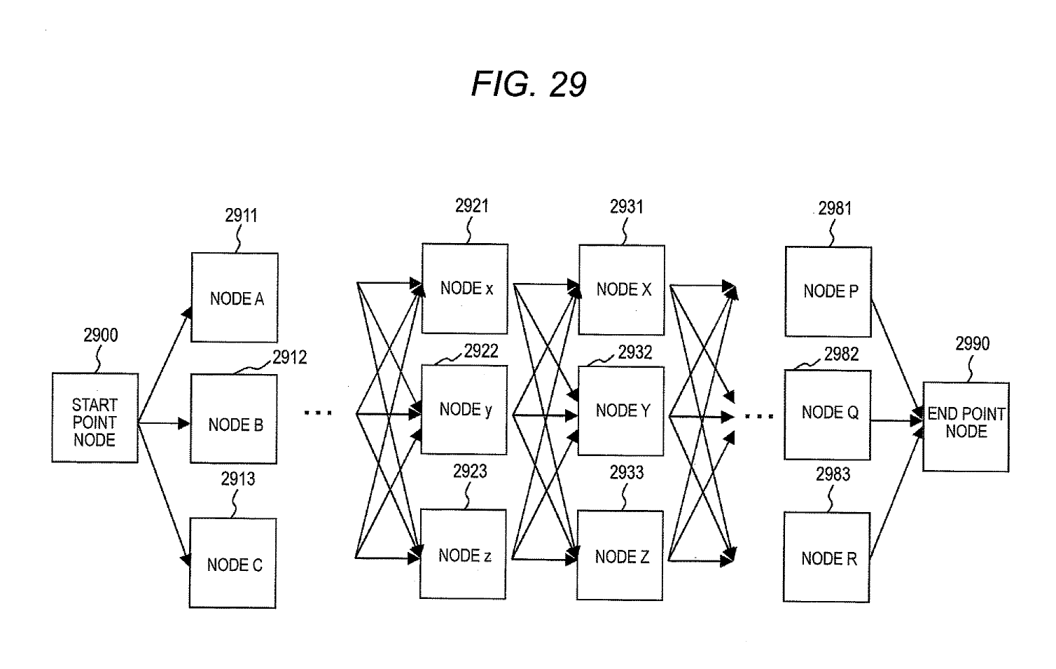

An example of FIG. 29 shows a graph including nodes from a start node 2900 to an end node 2990. Links between nodes are not limited to those shown in FIG. 29 but may be configured in different ways. These links may not have symmetrical wire connection as shown in FIG. 29.

As shown, this graph includes the start node 2900, a plurality of intermediate nodes (a middle node 2911, a middle node 2912, a middle node 2913, etc.) and the end node. An intermediate node is here called a middle node.

A link connects one node to another. A link is assigned with its unique evaluation value (a link value). There exists a plurality of paths routing from the start node 2900 to the end node 2990. A path includes a plurality of links. The sum of the link values of the plurality of links included in the path corresponds to a path evaluation value.

For example, it is assumed that a link value is a distance between one node and another. In this case, a path having the lowest path evaluation value corresponds to a path having the shortest distance among paths routing from the start node to the end node. This may be equally applied to find a path having the highest path evaluation value.

Here, a Viterbi algorithm is used to cancel paths which are not optimal by limiting a link input in a direction in any node to 1. This is a method for reducing the arithmetic processing amount and the memory capacity required.

For example, it is assumed that a link input from the left side to a node x (a middle node 2921) is limited to 1. Similarly, it is assumed that links for a node y (a middle node 2922) and a node z (a middle node 2923) are limited to 1. Then, a link input from the left side to a node X (a middle node 2923) is limited. The node X (the middle node 2931) is linked from three nodes, that is, the node x (the middle node 2921), the node y (the middle node 2922) and the node z (the middle node 2923). In this case, one of the links routing from the node x (the middle node 2921), the node y (the middle node 2922) and the node z (the middle node 2923) to the node X (the middle node 2931) is likely to be an optimal path passing the node X (the middle node 2931). Only the optimal node is left, the remaining two modes are eliminated among these three modes. In this manner, paths (or links) input from the left side to the node X (the middle node 2931) is limited to 1. Similarly, for a node Y (a middle node 2932) and a node Z (a middle node 2933), paths input from the left side are limited to 1.

This procedure is performed from a left node A (a middle 2911), a node B (a middle node 2912) and a node C (a middle node 2913) to the right direction in order. Finally, paths input to a node P (a middle node 2981), a node Q (a middle node 2982) and a node R (a middle node 2983) are limited to 3. Then, the optimal one among these paths may be selected. This optimal path selection method using the Viterbi algorithm may be equally applied to the graph illustrated in. FIG. 27. A character cutout position is assumed as a node. In addition, an arc evaluation value may be assumed as the above-described link value.

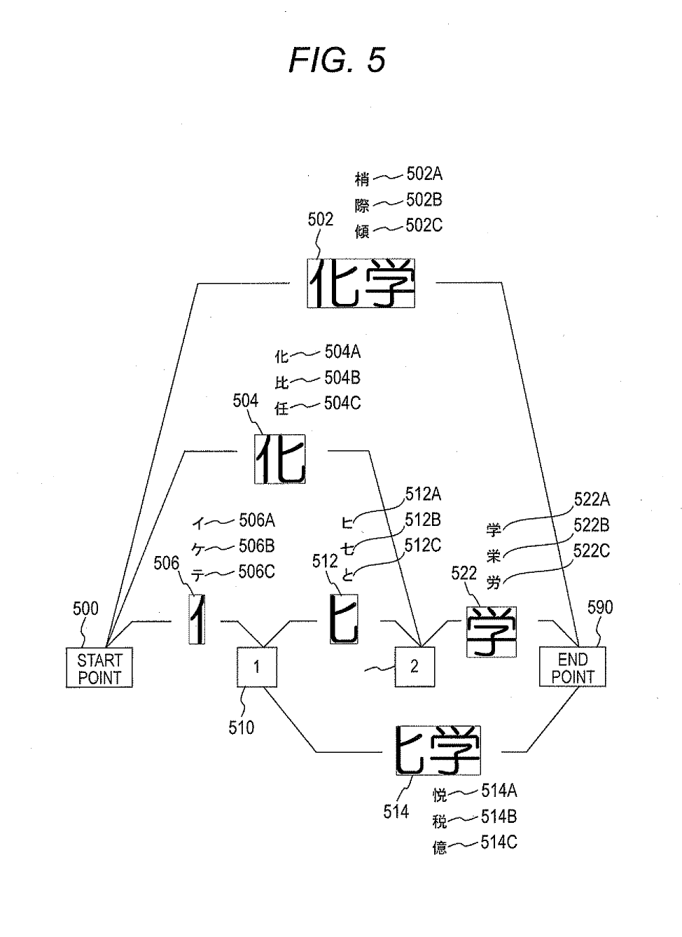

In the conventionally handled graph illustrated in FIG. 27, there exists a single character candidate for one arc. However, there actually exists a plurality of character candidates for one arc. That is, there exists a plurality of character recognition results. For example, a plurality of character candidates is assigned as shown in FIG. 5. FIG. 5 is an explanatory view illustrating an example of graph in the presence of a plurality of character candidates. In the example of FIG. 5, when an image, “ [symbol] ” (a character image 502), is recognized as one character, a recognition result includes three character candidates, that is, “ [symbol] ” (a character candidate 502A), “ [symbol] ” (a character candidate 502B), and “ [symbol] ” (a character candidate 502C). When an image “ [symbol] ” (a character image 504), is recognized as one character, a recognition result includes three character candidates, that is, “ [symbol] ” (a character candidate 504A), “ [symbol] ” (a character candidate 504B), and “ [symbol] ” (a character candidate 504C). Similarly, other character images may also include a plurality of character candidates as a character recognition result. Although the example of FIG. 5 shows three character candidates for each character image, fewer or more character candidates may be assigned. For example, if character images having recognition accuracy equal to or more than predetermined recognition accuracy are assigned as character candidates, a different number of character candidates may be assigned to different character images. In this case, conventional techniques could not obtain a character recognition result by applying the viterbi algorithm (generally, a dynamic programming method).

Hereinafter, an exemplary embodiment suitable for realizing the present invention will be described with reference to the drawings.

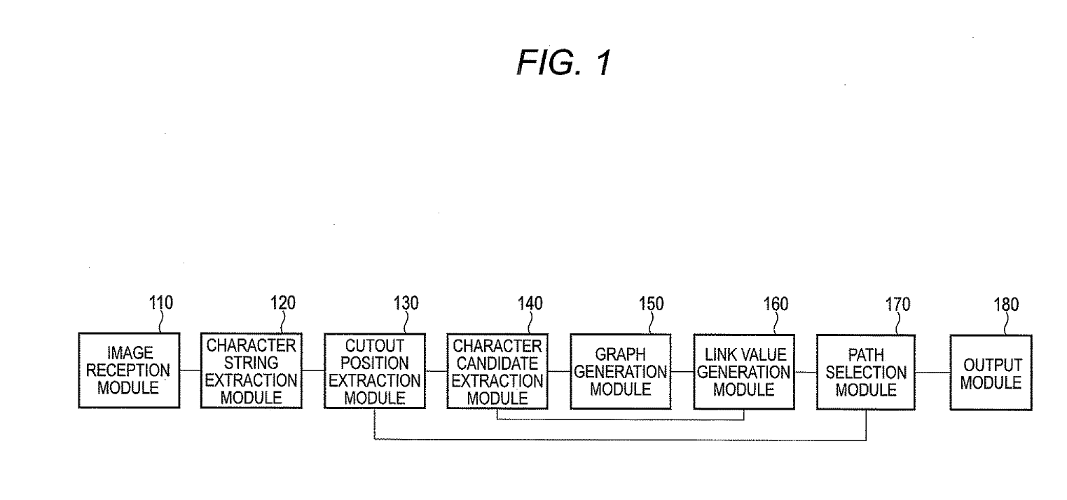

FIG. 1 is a conceptual module configuration view of an example of configuration according to this embodiment.

A “module” used herein refers generally to a part such as logically separable software (computer program), hardware and so on. Accordingly, a module in this embodiment includes not only a module in a computer program but also a module in hardware configuration. Thus, this embodiment addresses all of computer programs (including a program which causes a computer to execute steps, a program which causes a computer to function as means, and a program which causes a computer to realize functions) which causes this embodiment to function as modules, system and method. For the purpose of convenience of description, as used herein, “store,” “be stored” or its equivalent means that a computer program is stored in a storage unit or is controlled to be stored in a storage unit. Although the module is in one-to-one correspondence to a function, for mounting, one module may be configured as one program, a plurality of modules may be configured as one program, or reversely one module may be configured as a plurality of programs. A plurality of modules may be executed by one computer, or one module may be executed by a plurality of computers in distributed or parallel environments. One module may contain other modules. As used herein, the term “connection” includes logical connection (data delivery, instruction, reference relation between data, etc.) in addition to physical connection. As used herein, the term “predetermined” means determination before an object process, including not only determination before start of processing by the embodiment but also determination according to situations and conditions at that time or situations and conditions up to that time if this determination is determination before an object process even after start of processing by the embodiment.

As used herein, the term “system” or “apparatus” includes one computer, hardware, unit and the like in addition to a plurality of computers, hardware, units and the like interconnected via a communication means such as a network (including one-to-one correspondence communication connection). In the specification, “apparatus” is synonymous with “system.” Of course, the “system” does not include anything more than an artificial social “structure.” (social system)

When different modules perform different processes or one module performs different processes, information intended for processing is read from a storage unit and after this processing, a result of the processing is written in the storage. Thus, reading information out of the storage unit before processing and writing information in the storage unit after processing may not be explained. A storage unit used herein may include a hard disk, a random access memory (RAM), an external storage medium, a storage unit via a communication line, a register within a central processing unit (CPU), etc.

An image processing apparatus of this embodiment recognizes a character from an image and includes an image reception module 110, a character string extraction module 120, a cutout position extraction module 130, a character candidate extraction module 140, a graph generation module 150, a link value generation module 160, a path selection module 170 and an output module 180.

The image reception module 110 is connected to the character string extraction module 120. The image reception module 110 receives an image and delivers the image to the character string extraction module 120. The image reception includes, for example, reading an image with a scanner, a camera or the like, receiving an image from an external device with a facsimile or the like through a communication line, reading an image stored in a hard disk (including an internal hard disk of a computer, a hard disk connected over a network, etc.). An image may include a binary image and a multi-valued image (including a color image). The number of images to be received may be one or more. An image to be received may be an image of a document for use in a business, an image of a pamphlet for use in an advertisement as long as it contains a character string as its content.

The character string extraction module 120 is connected to the image reception module 110 and the cutout position extraction module 130. The character string extraction module 120 extracts a character string from the image received by the image reception module 110.

The cutout position extraction module 130 takes a single row of lateral or vertical-written character string image as an object. As used herein, the term ‘row’ refers to a laterally lined row in lateral writing or a vertically lined row in vertical writing.

Accordingly, if an image received by the image reception module 110 is a single row of character string image, the character string extraction module 120 may use the image as it is. An image received by the image reception module 110 may include a plurality of character strings. Since various conventional available methods for separating a plurality of character strings into individual character strings have been proposed, these may be used, and since there are various methods for separating a plurality of character strings into the individual character string, one of the methods may be used, including those disclosed in, for example, (1) JP-A-4-311283, (2) JP-A-3-233789, (3) JP-A-5-073718, (4) JP-A-2000-90194, etc. Other methods are also possible.

The cutout position extraction module 130 is connected to the character string extraction module 120, the character candidate extraction module 140 and the path selection module 170. The cutout position extraction module 130 extracts a character image cutout position from the character string image extracted by the character string extraction module 120. That is, the character string image is divided into a plurality of character segments. Various conventional available methods for extracting a character cutout position have been proposed, including those disclosed in, for example, (1) JP-A-5-114047, (2) JP-A-4-100189, (3) JP-A-4-092992, (4) JP-A-4-068481, (5) JP-A-9-054814, (6) a character boundary candidate extraction method described in paragraph [0021] of JP-A-9-185681, (7) a character cutout position determination method described in paragraph [0005] of JP-A-5-128308, etc. Other methods are also possible. Here, a character image refers to a character candidate image which may not be necessarily an image representing one character.

The cutout position extraction module 130 may extract a plurality of cutout positions. Extraction of a plurality of cutout positions produces a plurality of groups of character cutout positions for one character string image. A group of character cutout positions refers to one or more character cutout positions for one character string image. For example, two character cutout positions allow one character string image to be divided into three character images. In addition, a plurality of groups of character cutout positions refers to a plurality of character image strings divided at character cutout positions for one character string image. For example, two character cutout positions produce a character image string including three character images and three character cutout positions produce a character image string including four character images. As a specific example, for a character string, “ [symbol] ,” a character image string including “ [symbol] ”, “ [symbol] ” and “ [symbol] ” and a character image string including “ [symbol] ” and “ [symbol] ” are produced.

The character candidate extraction module 140 is connected to the cutout position extraction module 130, the graph generation module 150 and the link value generation module 160. The character candidate extraction module 140 extracts a plurality of character candidates which results from character recognition of a character image divided based on a position extracted by the cutout position extraction module 130. This extraction process may include a character recognition process. Thus, the character candidate extraction module 140 may include a character recognition module. A result of recognition by the character recognition process corresponds to a plurality of character candidates for one character image as described above. That is, the result of recognition for the character image corresponds to a plurality of character candidates including a character candidate having the first-ranked recognition accuracy, a character candidate having the second-ranked recognition accuracy, etc. In addition to the character candidates, the character recognition result may include recognition accuracy of the character candidates. In addition, in order to extract the character candidates, a predetermined number of character candidates may be extracted from one character image or character candidates having recognition accuracy equal to or more than predetermined recognition accuracy may be extracted from one character image. Recognition accuracy may be a value representing reliability of a recognition result of a character recognition process or a value representing a character-hood defined by a size, aspect ratio, etc. of a circumscribed rectangle of a character image.

The graph generation module 150 is connected to the character candidate extraction module 140 and the link value generation module 160. The graph generation module 150 generates a graph by setting a plurality of character candidates extracted by the character candidate extraction module 140 as nodes and establishing links between nodes of adjacent character images. As used herein, the term “between nodes of adjacent character images” refers to “between nodes corresponding to adjacent character images.”, while adjacent character images exist.

When the cutout position extraction module 130 extracts a plurality of cutout positions, the graph generation module 150 may generate a graph by setting a plurality of character candidates, which results from character recognition of a character image divided based on a plurality of cutout positions extracted by the cutout position extraction module 130, as nodes and establishing links between nodes of adjacent character images.

The link value generation module 160 is connected to the character candidate extraction module 140, the graph generation module 150 and the path selection module 170. The link value generation module 160 generates a link value based on a value representing a character-string-hood based on a relationship between character candidates of nodes connected by links in the graph generated by the graph generation module 150. Alternatively, the link value generation module 160 may generate a link value based on a value representing a character-hood for nodes constituting links.

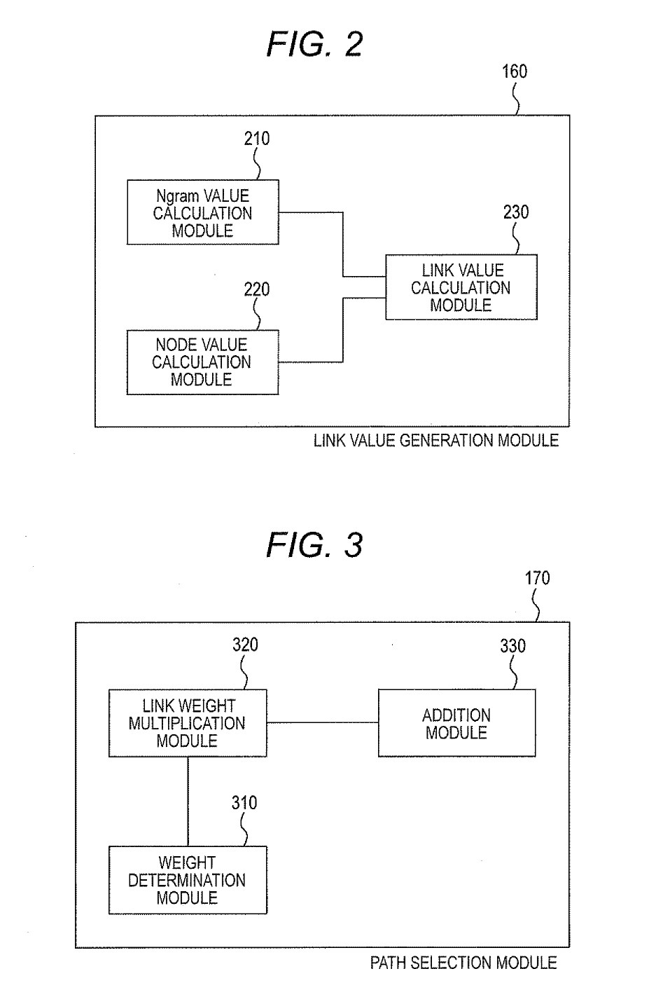

FIG. 2 is a conceptual module configuration view of an example of configuration of the link value generation module 160. The link value generation module 160 includes an Ngram value calculation module 210, a node value calculation module 220 and a link value calculation module 230.

The Ngram value calculation module 210 is connected to the link value calculation module 230 and generates a link value based on a value representing a character-string-hood based on a relationship between character candidates of a node connected by a link. For example, a probability that a character string constituted by character candidates corresponding to the node appears in a Japanese sentence is used as a link value. For example, a probability of a character string constituted by characters corresponding to a node in the left side of a link and a node in the right side thereof is referred to as a bigram. A probability of a character string including equal to or more than N characters by the link without being limited to two characters is referred to as an Ngram (N>2).

The node value calculation module 220 is connected to the link value calculation module 230 and extracts recognition accuracy, which is a value representing a character-hood of a character candidate corresponding to a node in one side of a link, as a node value from the character candidate extraction module 140. As described above, the node value calculation module 220 may extract recognition accuracy included in a character recognition result corresponding to a node.

The link value calculation module 230 is connected to the Ngram value calculation module 210 and the node value calculation module 220 and may calculate a link value based on a value representing a character-string-hood which is calculated by the Ngram value calculation module 210 or may calculate a link value based on a value representing a character-string-hood which is calculated by the Ngram value calculation module 210 and recognition accuracy calculated by the node value calculation module 220 (for example, an addition of two values, etc.).

The path selection module 170 is connected to the cutout position extraction module 130, the link value generation module 160 and the output module 180. The path selection module 170 selects a path in the graph, which is generated by the graph generation module 150, based on the link value generated by the link value generation module 160.

The path selected by the path selection module 170 represents a character string to be employed as a result of character recognition of a character image in the graph. This is because each node through which the path passes represents a character recognition result. The path selection module 170 may use a dynamic programming method to select a path based on the sum of link values while cutting paths in the course of process.

FIG. 3 is a conceptual module configuration view of an example of configuration of the path selection module 170. The path selection module 170 includes a weight determination module 310, a link weight multiplication module 320 and an addition module 330.

The weight determination module 310 is connected to the link weight multiplication module 320 and determines a weight based on a distance determined based on a character cutout position extracted by the cutout position extraction module 130.

In addition, the weight determination module 310 may determine a weight based on a size of a circumscribed rectangle of an image interposed between character cutout positions extracted by the cutout position extraction module 130.

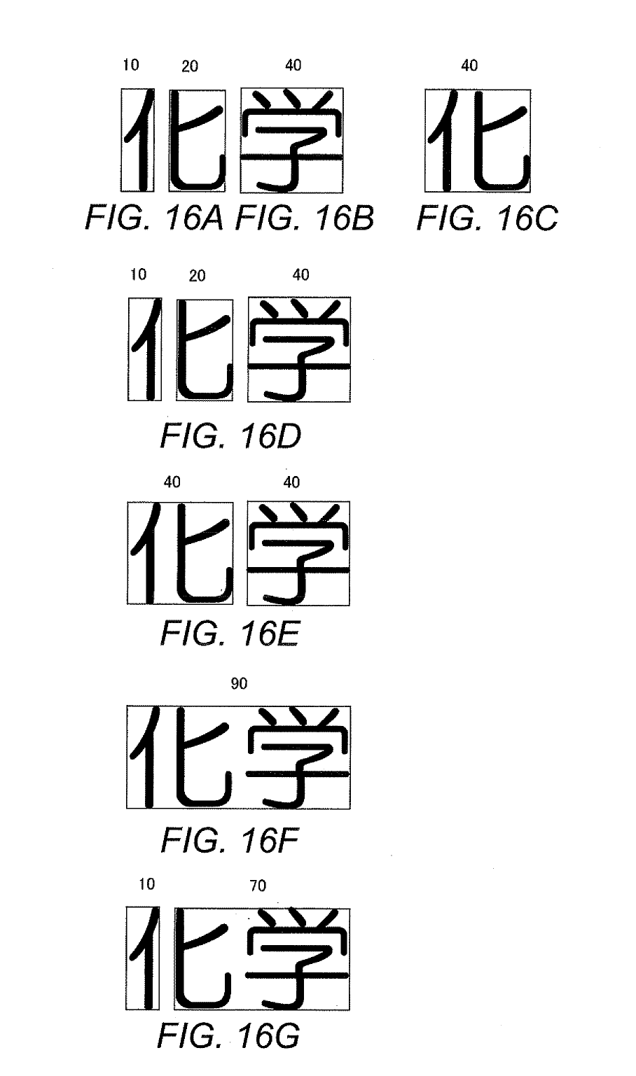

In addition, the weight determination module 310 may determine a weight based on the sum of sizes of circumscribed rectangles of a plurality of images interposed between character cutout positions extracted by the cutout position extraction module 130. A detailed configuration and process of the module in the weight determination module 310 will be described later with reference to examples of FIGS. 16A to 16G to FIG. 21.

The link weight multiplication module 320 is connected to the weight determination module 310 and the addition module 330 and multiplies the link value generated by the link value generation module 160 by a corresponding weight determined by the weight determination module 310.

The addition module 330 is connected to the link weight multiplication module 320 and adds results of multiplication of the link value by the weight, which are calculated by the link weight multiplication module 320. A result of this addition process corresponds to a (path unit) for each of a series of character cutout positions in an object character string image.

Accordingly, a process of the link weight multiplication module 320 and addition module 330 calculates the sum of weights of link value generated by the link value generation module 160 based on weights determined by the weight determination module 310.

The output module 180 is connected to the path selection module 170. The output module 180 outputs a character candidate string in the path, which is selected by the path selection module 170, as a character recognition result. Outputting the character recognition result includes, for example, printing it with a printing apparatus such as a printer, displaying it on a display apparatus such as a display, storing it in a storage medium such as a memory card, sending it to other information processing apparatuses, etc.

For example, for the following characters,

(1) “ [symbol] ”, “ [symbol] ” and “ [symbol] ” and

(2) “ [symbol] ” and “ [symbol] ”

since character recognition accuracy is little varied (individual characters usually have the same character-hood), the character string may be wrongly cut as shown in (1) if determined base on only the recognition accuracy.

However, when the link value generation module 160 generates a link value using Ngram information, the path selection module 170 selects (2). This is because “ [symbol] ” and “ [symbol] ” has a higher generation probability than that of “ [symbol] ” and “ [symbol] ” or “ [symbol] ” and “ [symbol] .”

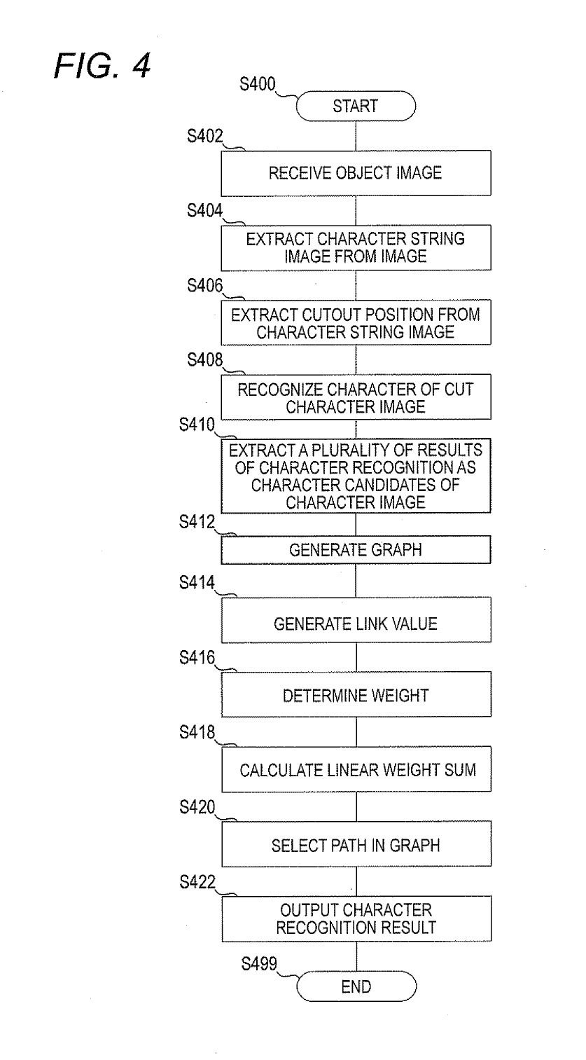

FIG. 4 is a flow chart illustrating an example of process according to this embodiment.

At Step S402, the image reception module 110 receives an object image.

At Step S404, the character string extraction module 120 extracts a character string image from the image.

At Step S406, the cutout position extraction module 130 extracts a cutout position from the character string image.

At Step S408, the character candidate extraction module 140 recognizes a character of a cut character image.

At Step S410, the character candidate extraction module 140 extracts a plurality of results of character recognition as character candidates of the character image.

At Step S412, the graph generation module 150 generates a graph.

At Step S414, the link value generation module 160 generates a link value.

At Step S416, the path selection module 170 determines a weight.

At Step S418, the path selection module 170 calculates linear weight sum.

At Step S420, the path selection module 170 selects a path in the graph.

At Step S422, the output module 180 outputs a character recognition result.

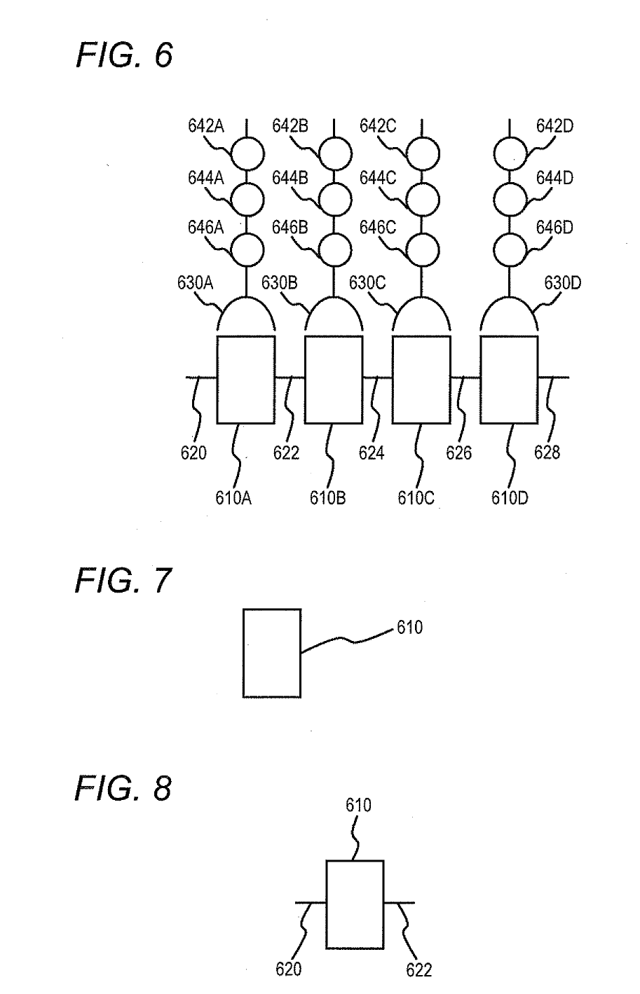

Next, processes by the graph generation module 150, the link value generation module 160 and the path selection module 170 will be described with reference to FIGS. 6 to 15.

This embodiment involves determining character cutout positions or recognizing characters by outputting paths having high path evaluation values. A dynamic programming method may be used for path search.

A graph of this embodiment includes a start node, an end node and a plurality of middle nodes. Link values are assigned to links between nodes. A path to reach from the start node, through one or more middle nodes, to the end node passes over links relying on intermediate nodes. A path evaluation value of the path reaching from the start node to the end node may be represented by the sum of weights of link values of link over which the path passes.

In this embodiment, if there exists a plurality of character recognition results for one character image, the graph generation module 150 generates the above-described node, link and path configuration (graph structure). With a given graph structure, the path selection module 170 can search for the optimal path using a method such as a viterbi algorithm.

<A1. Case Where Character Cutout Positions are Fixed>

First, a case where character cutout positions extracted by the cutout position extraction module 130 are fixed (that is, have just one type) will be described.

FIG. 6 is an explanatory view illustrating an example symbol. As shown, examples of symbols may include rectangles 610, lateral connection lines 620, 622, 624, 626 and 628, arcs 630, and circular character candidates 642, 644 and 646.

In the example of FIG. 6, the rectangles 610A, 610B, 610C and 610D (corresponding to a rectangle 610 illustrated in FIG. 7) represent character segments.

The lateral connection lines 620, 622, 624, 626 and 628 represent character cutout positions (corresponding to connection lines 620 and 622 illustrated in FIG. 8). The character segments are connected to adjacent character segments via the character cutout positions.

Character candidates 642A, 644A, . . . indicated by circles are a plurality of character candidates when one character segment is recognized as one character. Arcs 630A, 630B, 630C and 630D represent character recognition for only the one character segment shown under the arcs.

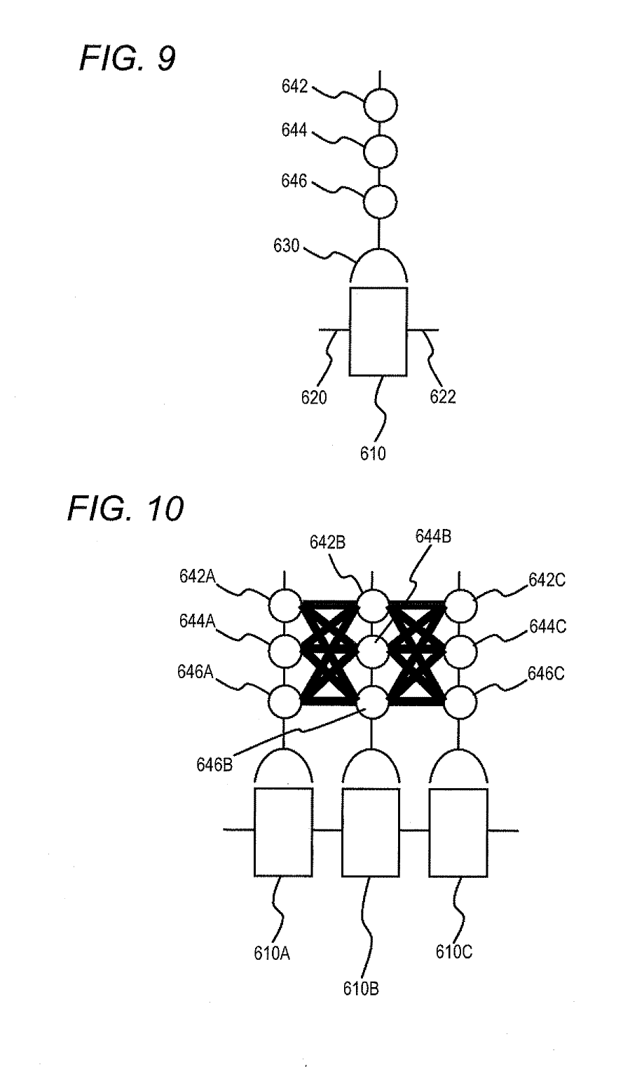

In an example of FIG. 9, character candidates 642, 644 and 646 are a plurality of character candidates when character segments of one character represented by a rectangle 610 shown under them are recognized. An arc 630 represents character recognition for only the one rectangle 610 shown under it.

In this embodiment, a plurality of character candidates of character segments is identified as nodes. Character candidates of adjacent character segments are connected to links. Example of FIG. 10 shows links indicated by bold lines.

Here, interaction of nodes in the left and right sides of a link may be used as a link value generated by the link value generation module 160. Specifically, a probability (bygram) that character candidates in the left side of a link and character candidates in the right side of the link appear continuously in a Japanese sentence is used.

When all graph structures can be specified by configuring nodes and links in this manner, if the gragh structures can be specified, an optimal path can be selected using a viterbi algorithm or the like.

<A2. Case Where Intra-Node Information is Also Used>

Although it has been illustrated in the above that only the interaction between nodes (a probability of appearance in a sentence) is used as link values, evaluation value of only nodes may be used as link values. Here, it is assumed that a viterbi algorithm is used to search for an optimal path. A process is performed which limits links entering from the left side of a node in order one by one for each node.

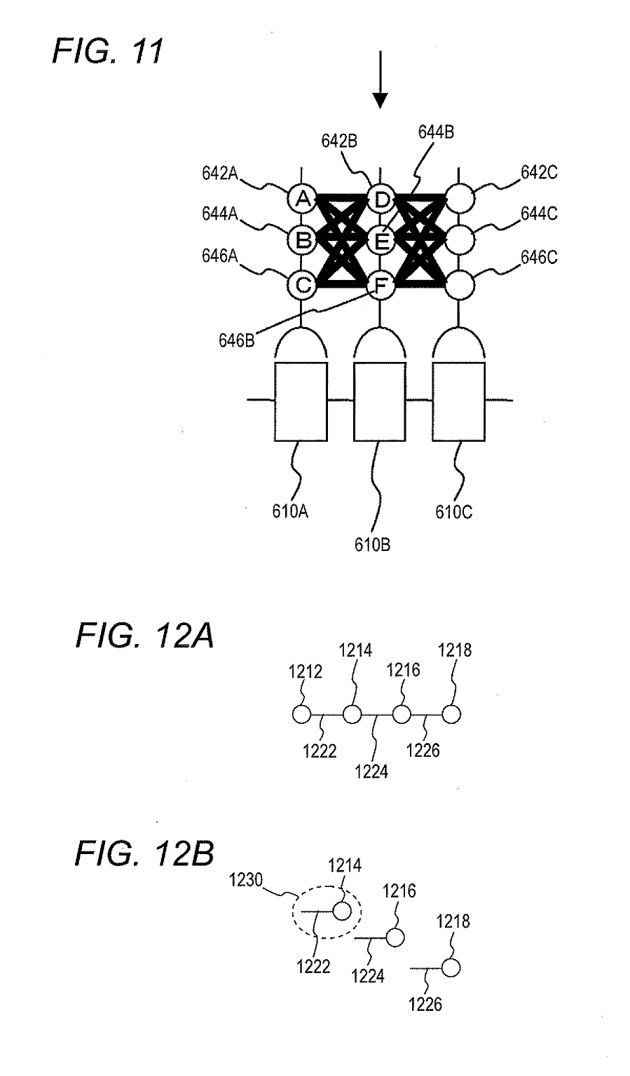

FIG. 11 is an explanatory view illustrating an example using intra-node information. Now, it is assumed that links of character candidates 642B, 644B and 646B (nodes D, E and F) indicated by arrows in the example of FIG. 11 are limited.

Here, link values between the character candidates 64213, 64413 and 646B (nodes D, E and F) indicated by arrows and character candidates 642A, 644A and 646A (nodes A, B and C) in the left side of the nodes indicated by the arrow are generated. Both of values such as bygrams representing the interaction between nodes and intra-node values are used as link values. An example of an intra-node value may include character recognition accuracy of the character candidate 642B (node D), etc.

Here, since links lie between the character candidates 642B, 644B and 646B (nodes D, E and F) and the character candidates 642A, 644A and 646A (nodes A, B and C), it is simple to calculate evaluation values between the character candidates 642B, 644B and 64613 (nodes D, E and F) and the character candidates 642A, 644A and 646A (nodes A, B and C) as link values. However, in this case, the intra-node values do not lie between the character candidates 642B, 644B and 646B (nodes D, E and F) and the character candidates 642A, 644A and 646A (nodes A, B and C) but lie in the character candidates 642B, 644B and 646B (nodes D, E and F).

That is, the inter-node information exists within a link and the intra-node information exists in an end point of a link. Handling values of these different generation positions or concepts altogether has been never suggested in the past.

In the past, arc evaluation values between nodes were calculated with the start node 2700, middle node 2710 (first node), middle node 2720 (second node) and end node 2790 (that is, character cutout positions) shown in FIG. 27 as nodes. This is not to calculate link values between nodes with a plurality of character codes as nodes as in this embodiment. Thus, the conventional technique cannot be used as it is.

In this embodiment, values existing within links (for example, bygram values) and values existing in only end points of one side of links (for example, character recognition accuracy of node D) are used as link evaluation values. Values existing in end points of the other side (for example, character recognition accuracy of node A) are not used. Thus, an evaluation using the intra-link values and the link end point values together is possible.

Finally, in Equation (1), evaluation values of all links are added to generate a character string evaluation value (a path evaluation value). Accordingly, if intra-link evaluation values and evaluation values of end points of one side of links are included in link evaluation values, this means that all of the intra-link evaluation values and link end point evaluation values are one each included in the path evaluation value.

This relationship is schematically shown in FIGS. 12A and 12B. FIGS. 12A and 12B are explanatory views illustrating an example of node and link. In the example of FIGS. 12A and 128, circles represent nodes such as a node 1212. Lateral lines represent links such as a link 1222. As shown in the example of FIG. 128, one link value (link evaluation unit 1230) represents an evaluation of one node (node 1214) and an evaluation of one link (link 1222).

Accordingly, in the example of FIGS. 12A and 12B, nodes other than the leftmost end point node (node 1212) can be evaluated by adding three link evaluation results. Only an intra-node evaluation value of the node of the left end point is calculated with the left end point process and is added to the path evaluation value. Alternatively, a process may be performed which adds the intra-node evaluation value of the left end point and the leftmost link value.

The link value generation module 160 may calculate a link value from a plurality of values (bygram and recognition accuracy) as features, such as the above described intra-link values and link end point values. A Method of calculating one link from the plurality of value in this manner may employ any of techniques disclosed in (1) JP-A-9-185681, (2) JP-A-61-175878, (3) JP-A-3-037782, (4) JP-A-11-203406, etc. Other methods are also possible.

In addition, with the plurality of value as feature vectors, link values may be implemented as a function of outputting link evaluation values (scalar values) for the feature vectors.

<A3. Case Where Two or More Nodes are Used as Link Information>

It has been illustrated in the above that bygrams are used as mutual information of nodes in the left and right sides of a link. In this case, relationship information between two nodes is used as link information.

With use of a viterbi algorithm, for example, the number of links in the left side of node A, B and C is limited to 1. In this case, it is possible to construct link information using information of two or more nodes.

For example, it is possible to use trigram, which is a probability of generation of three consecutive characters, without the bygram which is a probability of generation of two consecutive characters.

Now, it is assumed that the link value generation module 160 generates a link value in the left side of nodes D, E and F.

For example, a link value between node A and node D is calculated. For bygram, a generation probability of consecutive node A and node D may be obtained. Here, a case where trigram is obtained will be described. Since the number of links in the left side of node A is limited to 1, a character in the left side of node A is also actually determined. A node to retain this character is set to G. For trigram, a generation probability of three characters of node G node A and node D may be obtained. The above-obtained trigram may be generated as a link value between node A and node D. Similarly, Ngram may be obtained.

<A4. Case Where Character Cutout Positions are Not Determined>

If character cutout positions are not determined (that is, the cutout position extraction module 130 extracted a plurality of character cutout positions), character candidates and character cutout positions may be selected.

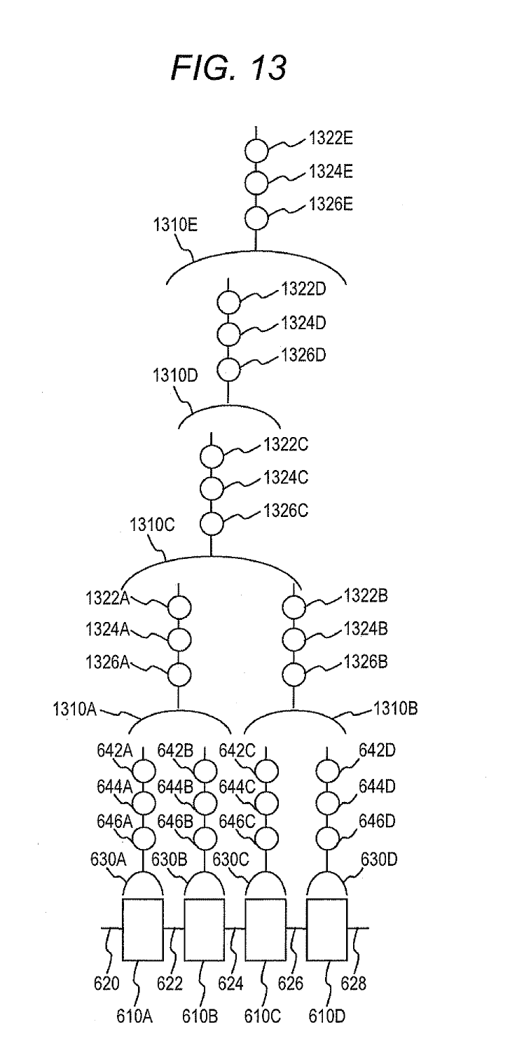

FIG. 13 is an explanatory view illustrating an example of process in the presence of a plurality of character cutout positions. Here, a meaning of an arc symbol is added. If an arc represents a plurality of character segments (rectangles) under it, the arc represents recognition of an image generated by a combination of the plurality of character segments as one character. An arc 1310A includes character candidates 1322A, 1324A and 1326A as a character recognition result of an image generated by a combination of a rectangle 610A and a rectangle 610B as one character. In addition, an arc 1310C includes character candidates 1322C, 1324C and 1326C as a character recognition result of an image generated by a combination of rectangles 610A, 610B, 610C and 610D as one character.

As shown in an example of FIG. 14, if two character segments (rectangle 610A and rectangle 610B), “ [symbol] ” and “ [symbol] ” lie below an arc 630A and an arc 630B, character candidates 1322, 1324 and 1326 above an arc 1310 including the two character segments correspond to a plurality of character candidates when one character segment, “ [symbol] ,” generated by a combination of “ [symbol] ” and “ [symbol] ,” is recognized.

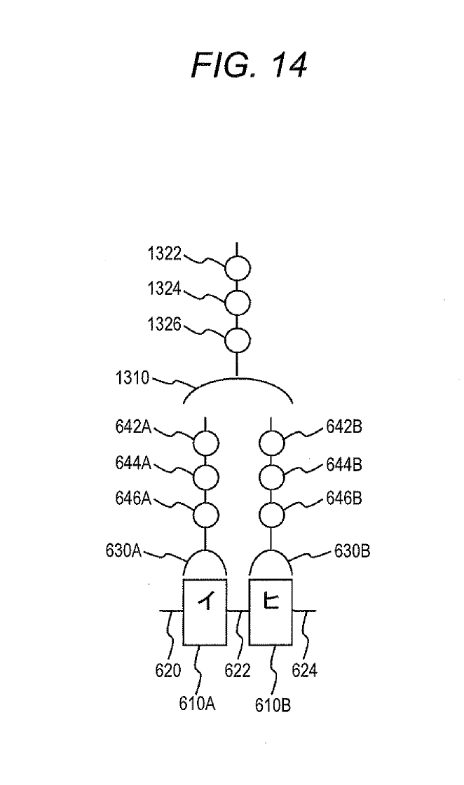

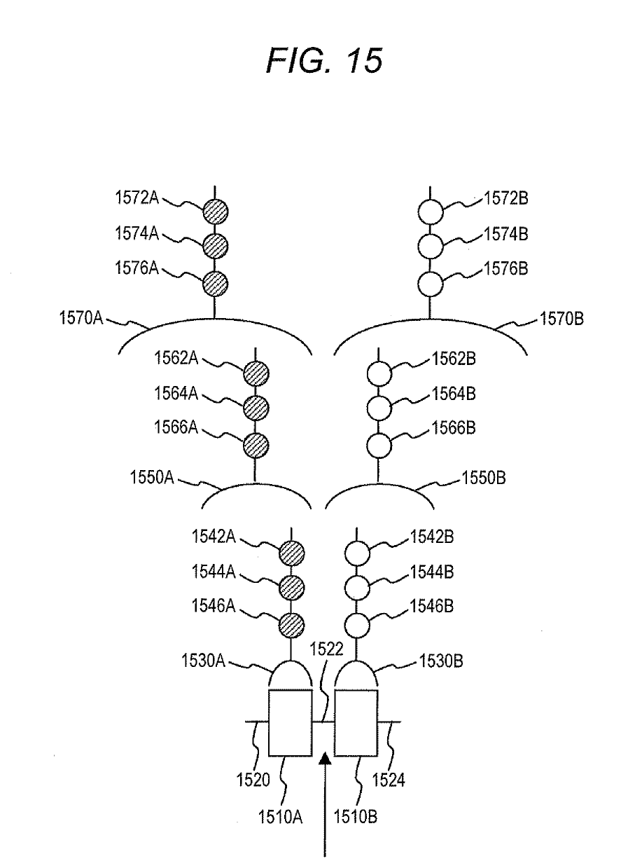

Link connection when character cutout positions are not determined is shown in an example of FIG. 15. FIG. 15 is an explanatory view illustrating an example of process in the presence of a plurality of character cutout positions.

Here, character cutout positions are considered. Now, links of nodes associated with a character cutout position indicated by an arrow in FIG. 15 is targeted. An example of nodes linked at this character cutout position may include two types of nodes:

(1) left nodes: nodes in which the right side of an arc exists in the character cutout position indicated by the arrow (hatched nodes; a character candidate 1542A, a character candidate 1544A, a character candidate 1562A, a character candidate 1564A, a character candidate 1572A, a character candidate 1574A, etc. in the oblique line), and

(2) right nodes: nodes in which the left side of an arc exists in the character cutout position indicated by the arrow (white nodes; a character candidate 1542B, a character candidate 1544B, a character candidate 156213, a character candidate 1564B, a character candidate 1572B, a character candidate 1574B, etc.).

In this case, a graph structure can be established by forming links between the left nodes and the right nodes.

For example, links may be formed to allow all the left nodes to be directly connected to all the right nodes. In addition, it is possible to establish all graph structures by forming links of the left nodes and the right nodes as described above at all the character cutout positions, connecting the left nodes to the start node if the left nodes are end points of the character string, and connecting the right nodes to the end node if the right nodes are end points of the character string.

Also in this case, link values representing interaction between nodes in the left and right sides of a link may be used or intra-node evaluation values may be used.

In particular, in this case, since the character cutout positions are not determined, character shape information may be used as intra-node evaluation values. Examples of the character shape information may include a character aspect ratio, character left and right blanks, etc.

Next, a weighing process by the weight determination module 310 of the path selection module 170 will be described with reference to FIGS. 16A to 16G to FIG. 21.

<B1>

FIG. 16 is an explanatory view illustrating an example weight.

Here, a character string image, “ [symbol] ,” illustrated in FIG. 23 will be described by way of example. A weight is assumed to be the number of pixels. As illustrated in FIGS. 16A, 16B and 16C, a width of “ [symbol] ” corresponds to 10 pixels, a width of “ [symbol] ” corresponds to 20 pixels, a width of “ [symbol] ” corresponds to 40 pixels and a width of “ [symbol] ” corresponds to 40 pixels. A width of a blank between one character segment and another corresponds to 10 pixels. In this case, weights for arc evaluation values in patterns are as shown in examples of FIGS. 16D to 16G That is, distances defined by candidates at positions set by the character cutout position determined module 110 (hereinafter referred to as “cutout position candidates”) are weighted. In this example, assuming that there is one character image between adjacent cutout position candidates, a distance defined by cutout position candidates corresponds to a width of a circumscribed rectangle of the character image. In addition, the distance defined by cutout position candidates may be referred to as a distance between adjacent cutout position candidates.

Although a weight shown in the example of FIG. 16F is higher than a weight shown in the example of Fig. E, in many cases, a path evaluation value of the example of FIG. 16E may become high due to an arc evaluation value (a character-hood evaluation value when each of “ [symbol] ” and “ [symbol] ” is assumed as one character and a character-hood evaluation value when “ [symbol] ” is assumed as one character).

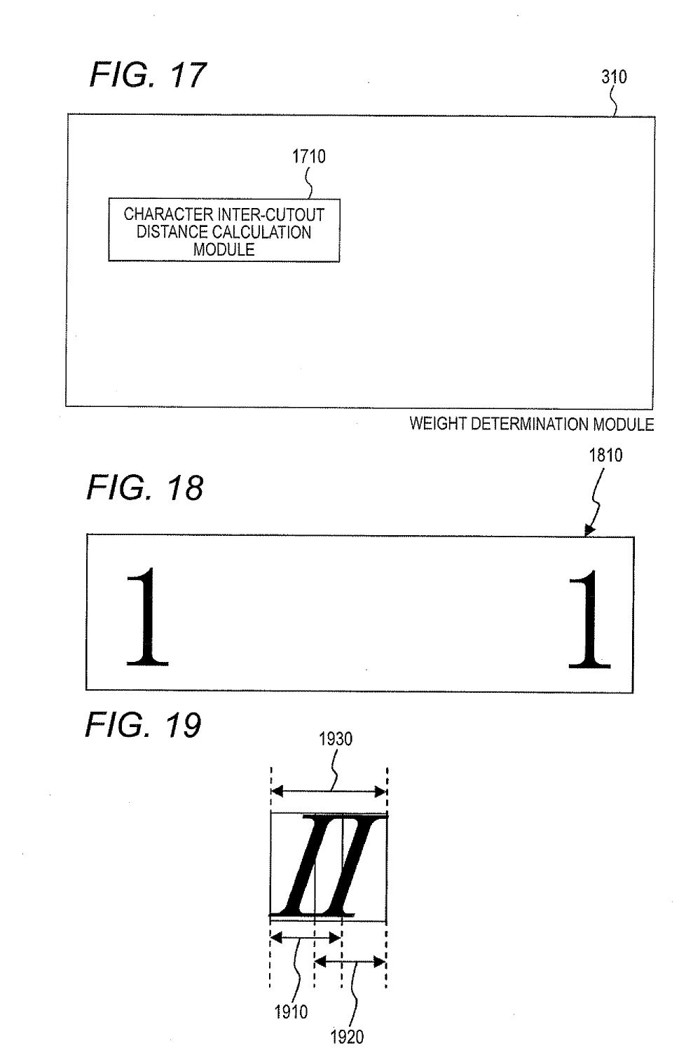

FIG. 17 is an explanatory view illustrating an example of module configuration of the weight determination module 310.

The weight determination module 310 includes a character inter-cutout distance calculation module 1710. The character inter-cutout distance calculation module 1710 determines a weight based on a width of a circumscribed rectangle of one character image between adjacent cutout position candidates. In addition, this module 1710 may determine a weight based on a distance between adjacent cutout position candidates.

<B2>

In the above-described <B1>, a width of a circumscribed rectangle of a character image or a distance between adjacent cutout position candidates was weighted as it is. In this case, an internal highly-blanked character may have a higher weight than is needed.

For example, as illustrated in FIG. 18, if a highly-blanked character is selected within a character inter-cutout distance 1810, a weight becomes higher than is needed. In the example of FIG. 18, a result of character recognition for an image “ [symbol] ” within the character inter-cutout distance 1810 may show “ [symbol] .” In this case, since a weight value increases, “ [symbol] ” may be selected as one character (that is, result of character recognition may show “ [symbol] ”).

In addition, a weight is lower than is needed if character segments overlap with each other, as shown in an example of FIG. 19 if circumscribed rectangles of character segments overlap with each other, since a weight value of a character segment divided into two smaller character segments increases, the character segment is more likely to be “ [symbol] ,” “ [symbol] ” but not “ [symbol] ” (Roman numeral of 2). That is, since the sum of a circumscribed rectangle width 1910 and a circumscribed rectangle width 1920 increases over a character inter-cutout distance 1930, a cutout position of each character segment is more likely to be employed as a character cutout position.

Accordingly, a weight is determined based on a size of a circumscribed rectangle of a character segment (a width for a lateral-written character string image or a height for a vertical-written character string image) within a character (an image between adjacent cutout position candidates).

If there is a plurality of character segments within a character, a weight may be determined based on the sum of sizes of circumscribed rectangles of the character segments.

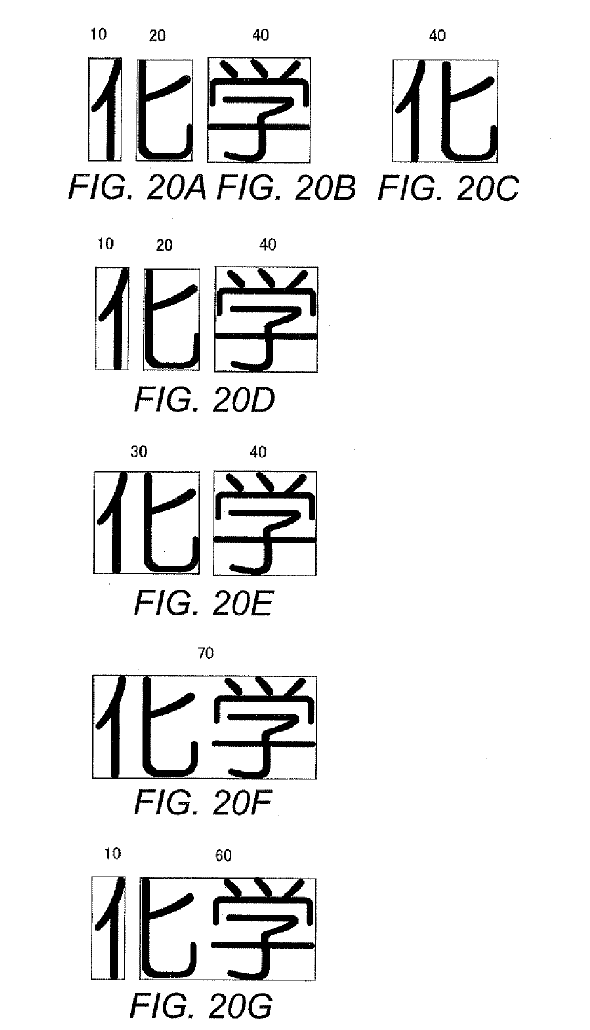

As illustrated in FIGS. 20A, 20B and 20C, a width of “ [symbol] ” corresponds to 10 pixels, a width of “ [symbol] ” corresponds to 20 pixels, a width of “ [symbol] ” corresponds to 40 pixels and a width of “ [symbol] ” corresponds to 40 pixels. A width of a blank between one character segment and another corresponds to 10 pixels. In this case, weights for arc evaluation values in patterns are shown as in examples of FIG. 20D to 20G. That is, a width of a circumscribed rectangle of a character segment (the sum of widths if there is a plurality of character segments) becomes a weight.

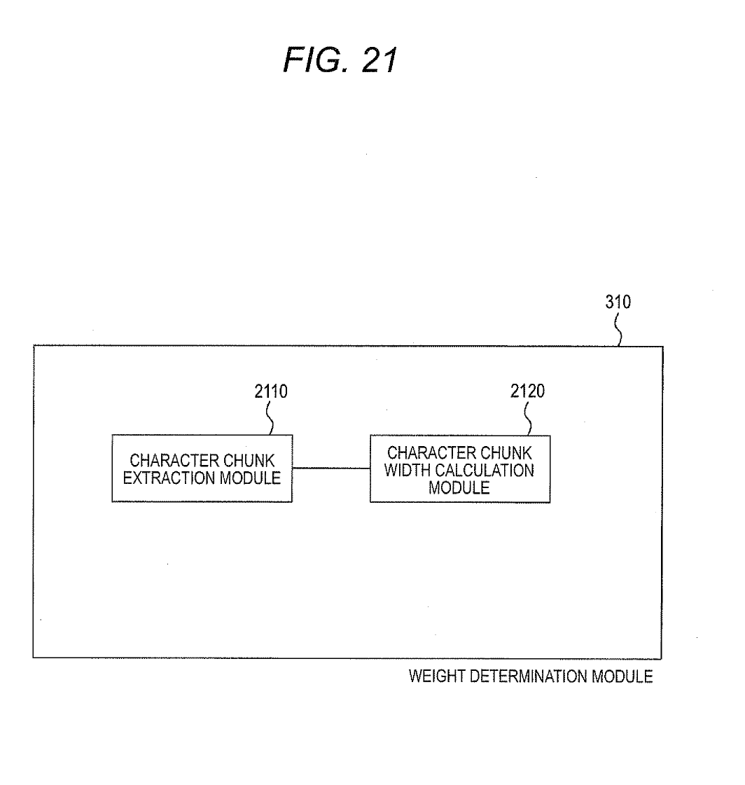

FIG. 21 is an explanatory view illustrating an example of module configuration of the weight determination module 310.

The weight determination module 310 includes a character chunk extraction module 2110 and a character chunk width calculation module 2120.

The character chunk extraction module 2110 is connected to the character chunk width calculation module 2120 and extracts a character segment (pixel chunk) between adjacent cutout position candidates. For example, a 4-chained or 8-chained pixel chunk may be extracted as a character segment. In addition, a profile of a character in a lateral direction may be taken. That is, a histogram having a number of black pixels in the lateral direction is calculated. In addition, this black pixel histogram may be used to extract a character segment.

The character chunk width calculation module 2120 is connected to the character chunk extraction module 2110 and determines a weight by calculating a size of a circumscribed rectangle of the character segment extracted by the character chunk extraction module 2110.

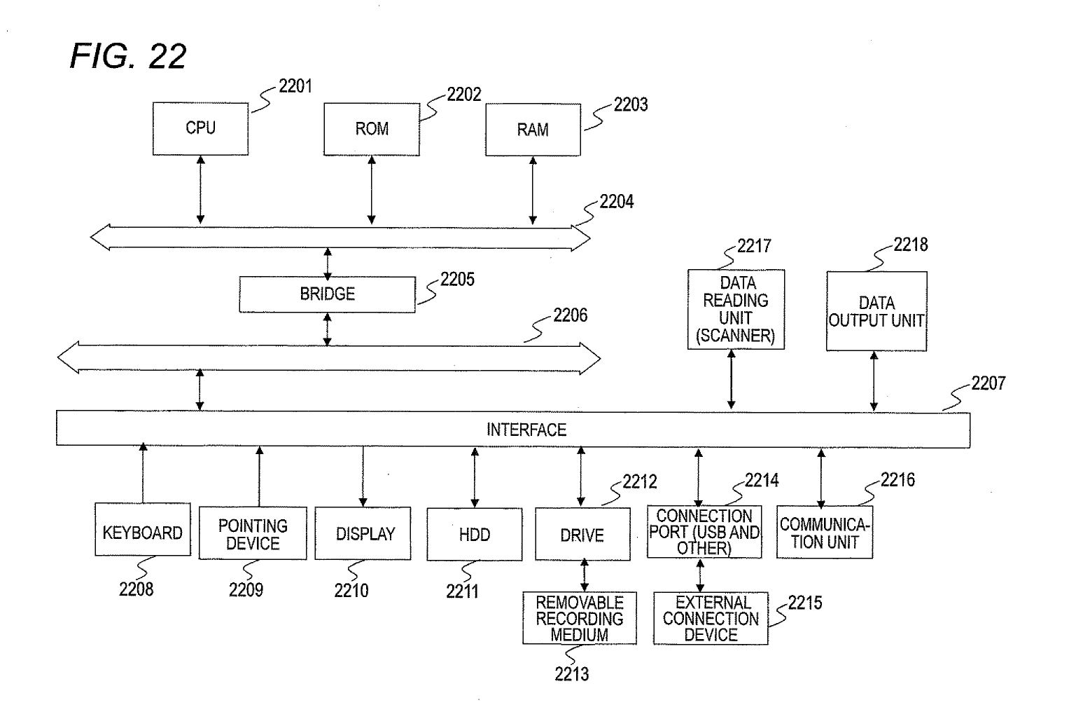

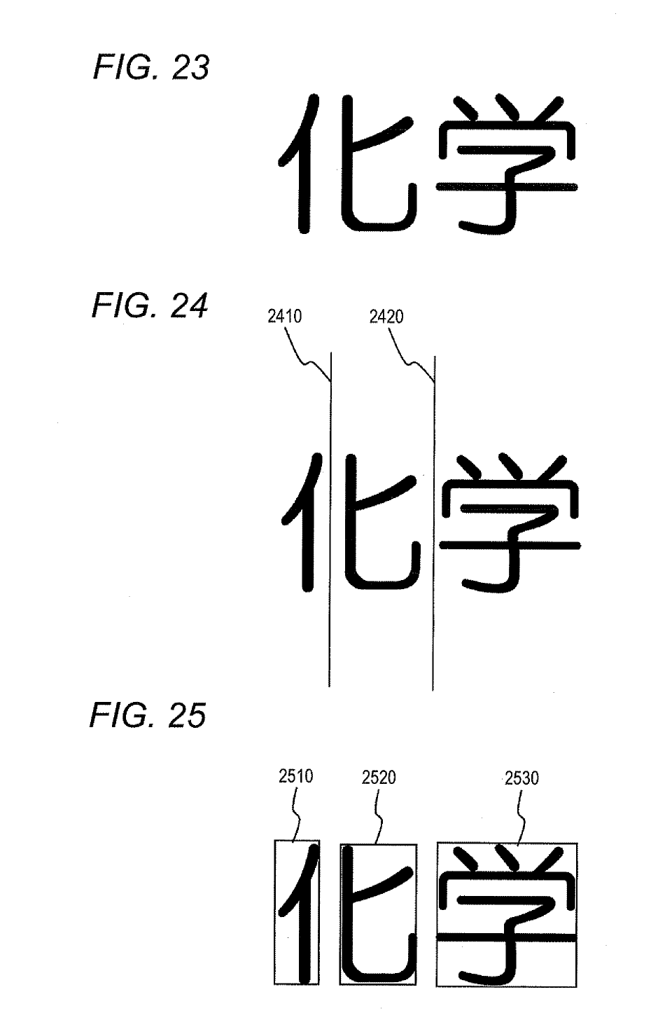

Now, an example of hardware configuration of the image processing apparatus of this embodiment will be described with reference to FIG. 22. The hardware configuration shown in FIG. 22 is configured by, for example, a personal computer (PC) or the like, including a data reading unit 2217 such as a scanner or the like, a data output unit 2218 such as a printer or the like.

A central processing unit (CPU) 2201 is a controller for executing a process according to a computer program described by an execution sequence of various modules described in the above embodiment, such as the character string extraction module 120, the cutout position extraction module 130, the character candidate extraction module 140, the graph generation module 150, the link value generation module 160, the path selection module 170 and so on.

A read only memory (ROM) 2202 stores programs, operation parameters and so on used by the CPU 2201. A random access memory (RAM.) 2203 stores programs used for execution by the CPU 2201, parameters properly changed for the execution, etc. These memories are interconnected via a host bus 2204 such as a CPU bus or the like.

The host bus 2204 is connected to an external bus 2206 such as a peripheral component interconnect/interface (PCI) bus or the like via a bridge 2205.

A point device 2209 such as a keyboard 2208, a mouse or the like is an input device manipulated by an operator. A display 2210, such as a liquid crystal display apparatus, a cathode ray tube (CRT) or the like, displays various kinds of information as text or image information.

A hard disk drive (HDD) 2211 contains a hard disk and drives the hard disk to record or reproduce programs or information executed by the CPU 2201. The hard disk stores received images, results of character recognition, graph structures, etc. In addition, the hard disk stores various kinds of computer programs such as data processing programs.

A drive 2212 reads data or programs recorded in a removable recording medium 2213 mounted thereon, such as a magnetic disk, an optical disk, a magneto-optical disk, a semiconductor memory or the like, and supplies the read data or programs to the RAM 2203 via an interface 2207, the external bus 2206, the bridge 2205 and the host bus 2204. The removable recording medium 2213 may also be used as a data recording region like the hard disk.

A connection port 2214 is a port which is connected to an external connection device 2215 and includes a connection unit such as a USB, IEEE1394 or the like. The connection port 2214 is also connected to the CPU 2201 and so on via the interface 2207, the external bus 2206, the bridge 2205, the host bus 2204 and so on. A communication unit 2216 is connected to a network for conducting data communication with the external. The data reading unit 2217 is, for example, a scanner for reading a document. The data output unit 2218 is, for example, a printer for outputting document data.

The hardware configuration of the image processing apparatus shown in FIG. 22 is a example of the configuration, and this embodiment is not limited to the hardware configuration shown in FIG. 22 but may have any configuration as long as it can execute the modules described in this embodiment. For example, some modules may be configured as a dedicated hardware (for example, ASIC (Application Specific Integrated Circuit) or the like), some modules may be in an external system and connected via a communication link, and additionally a plurality of the system shown in FIG. 22 may be interconnected via a communication link to cooperate between them. In addition, the hardware configuration may be assembled in a copier, facsimile, scanner, printer, a multifunction copier (image processing apparatus having two or more of functions of scanner, printer, copier and facsimile and the like), etc.

Although Japanese characters have been illustrated as objects in the above-described embodiment, characters in Chinese, English and so on may be the objects.

In the above-described embodiment, with the lateral-written character string as the premise, the start point lies in the left side and the end point lies in the right side. However, this description may be equally applied to a vertical-written or right to left-written character string. For example, for the vertical-written character string, “left” and “right” may be changed to “top” and “bottom,” respectively. For the right to left-written character string, “left” and “right” may be changed to “right” and “left,” respectively.

In addition, the equation used in this embodiment may include its equivalents. “Its equivalents” may include modifications of the equation which are so modified that they have no effect on a final result, algorithmic solutions of the equation, etc.

The above-described program may be stored in a recording medium and provided or may be provided by a communication means. In this case, for example, the above-described program may be understood as the invention of “computer-readable recording medium having a program recorded therein.”

“Computer-readable recording medium having a program recorded therein” refers to a computer-readable recording medium having a program recorded therein, which is used for installation, execution, distribution and so on of the program.

The recording medium may include, for example, a digital versatile disc (DVD) such as “DVR-R, DVD-RW, DVD-RAM and the like”, which are a standard specified by DVD Forum, and “DVD+R, DVD+RW and the like”, which are a standard specified as DVD+RW, a compact disc (CD) such as read-only memory (CD-ROM), CD recordable (CD-R), CD rewritable (CD-RW) or the like, a blue-ray disc®, a magneto-optical disc (MO), a flexible disc (FD), a magnetic tape, a hard disk, a read only memory (ROM), an electrically erasable programmable read-only memory (EEPROM®), a flash memory, a random access memory (RAM), etc.

The program or a part thereof may be recorded in the recording medium for storage and distribution. In addition, the program or a part thereof may be transmitted via a communication means, for example, a transmission medium such as a wired network or a wireless network used for a local area network (LAN), metropolitan area network (MAN), wide area network (WAN), Internet, intranet, extranet and so on, or further a combination thereof, or may be carried using a carrier wave.

The program may be a part of other program or may be recorded in the recording medium along with a separate program. In addition, the program may be divided and recorded in a plurality of recording media. In addition, the program may be recorded in any form including compression, encryption and so on as long as it can be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a cutout position extraction unit that extracts a cutout position to divide character images from an image;
a character candidate extraction unit that recognizes each character for each character image divided by the cutout position extracted by the cutout position extraction unit and that extracts a plurality of character candidates for each recognized character;
a graph generation unit that sets each of the plurality of character candidates extracted by the character candidate extraction unit as a node and that generates a graph by establishing links between the nodes of adjacent character images;
a link value generation unit that generates a link value based on a value of character-string-hood which represents a relationship between character candidates of the nodes connected by the links;
a path selection unit that selects a path in the graph generated by the graph generation unit based on the link value generated by the link value generation unit; and
an output unit that outputs a character candidate string in the path selected by the path selection unit as a result of character recognition of the image processing apparatus.

2. The image processing apparatus according to Claim I,
wherein the path selection unit uses a dynamic programming method to select a path based on the sum of link values while canceling and reducing paths in the course of process.

3. The image processing apparatus according to claim 1,
wherein the link value generation unit generates the link value based on a value representing character-hood for nodes constituting the links.

4. The image processing apparatus according to claim 1,
wherein the cutout position extraction unit extracts a plurality of cutout positions,
wherein the graph generation unit sets each of a plurality of character candidates as a node, each of a plurality of character candidates of which character is recognized for each character image divided by the plurality of cutout positions extracted by the cutout position extraction unit; and
wherein the graph generation unit generates a graph by establishing links between nodes of adjacent character images.

5. An image processing method comprising:
extracting a cutout position to divide character images from an image;
recognizing each character for each character image divided by the extracted cutout position;
extracting a plurality of character candidates for each recognized character;
setting each of the extracted plurality of character candidates as a node;
generating a graph by establishing links between the nodes of adjacent character images;
generating a link value based on a value of character-string-hood which represents a relationship between character candidates of the nodes connected by the links;
selecting a path in the generated graph based on the generated link value; and
outputting a character candidate string in the selected path as a result of character recognition of the image processing method.

6. A non-transitory computer-readable medium storing a program that causes a computer to execute image processing, the image processing comprising:
extracting a cutout position to divide character images from an image;
recognizing each character for each character image divided by the extracted cutout position;
extracting a plurality of character candidates for each recognized character;
setting each of the extracted plurality of character candidates as a node;
generating a graph by establishing links between the nodes of adjacent character images;
generating a link value based on a value of character-string-hood which represents a relationship between character candidates of the nodes connected by the links;
selecting a path in the generated graph based on the generated link value; and
outputting a character candidate string in the selected path as a result of character recognition of the image processing.
